(19) United States
(12) Patent Application Publication
(10) Pub. No.: US 2003/0071480 A1
(43) Pub. Date: Apr. 17, 2003

(54) Car shade and flood protection arrangement

(76) Inventor: Liu Wen Hsiang, Tainan (TW)

Correspondence Address: Keith Kline,, PRO-TECHTOR INTERNATIONAL SERVICES, 20775 Norada Court, Saratoga, CA, 95070-3018, US

(21) Appl. No.: 10/238,149

(22) Filed: Sep. 9, 2002

(30) Foreign Application Priority Data
Oct. 17, 2001 (TW) 90217687

(51) Int. Cl. B60J 11/00

(52) U.S. Cl. 296/136

(57) ABSTRACT

A car shade and flood protection arrangement includes a car shade for covering the whole body of a car, a sensor adapted to detect water level upon a flood, a water bag to be mounted in the car covered by the car shade, and a water pump adapted to pump water from the flood into the water bag to increase the weight of the car and to prevent the car from floating in the flood when the water level of the flood surpassed a predetermined level.

### BACKGROUND OF THE INVENTION

1. Field of the Invention

The present invention relates to a car shade and flood protection arrangement of equivalent Taiwan Patent Application No. 90217687 filed on Oct. 17, 2001, allowed and published on Oct. 21, 2002.

2. Brief Description of the Related Art

Conventional car shades are simply used to keep a car from the light of the sun and, to protect a car against scratching or rubbing of external object. However, the car shade tends to be forced away from the car by a strong wind when storming. Further, a conventional car shade cannot stop the water of a flood from entering the car.

It is known that water does not fill up the holding space of a container completely when the container holding a certain amount of air and keeping the opening thereof toward the bottom side under the water.

### SUMMARY OF THE INVENTION

The present invention has been accomplished under the circumstances in view. It is the main object of the present invention to provide a car shade, which effectively keeps the car from the light of the sun and, protects the car against scratching or rubbing of external object. It is another object of the present invention to provide a car shade, which prohibits water from entering the car under protection when a flood occurred. It is still another object of the present invention to provide a car shade, which does not fly away from the car under protection upon a storm. It is still another object of the present invention to provide a car shade and flood protection arrangement, which prevents floating of the car in water when a flood occurred. According to one aspect of the present invention, the car shade and flood protection arrangement comprises a car shade adapted for covering the whole body of a car around the wheels, the car shade comprising a hollow waterproof inner layer fitting over the body of the car to be protected, a meshed outer layer made of tough material and fastened to the waterproof inner layer, and a pull cord adapted to fasten the inner layer and the outer layer to the bottom side of the wheels of the car to be protected. The pull cord has two cord sections and a spring member connected between the cord sections. The spring member sets off the force of a strong wind, preventing the car shade from been forced out of the car by a strong wind. According to another aspect of the present invention, the car shade and flood protection arrangement further comprises a sensor adapted to detect water level upon a flood, a water bag to be mounted in the car covered by the car shade, and a water pump adapted to pump water from the flood into the water bag to increase the weight of the car and to prevent the car from floating in the flood when the water level of the flood surpassed a predetermined level.

### BRIEF DESCRIPTION OF THE DRAWINGS

FIG. 1 is a sectional view of the present invention, showing the car shade installed in the car.

FIG. 2 is a perspective view of a part of the car shade according to the present invention.

FIG. 3 is a schematic drawing showing the installation operation of the car shade according to the present invention.

FIG. 3A is an enlarged view of a part of FIG. 3, showing the structure of the pull cord.

FIG. 4 is a schematic drawing showing the water pump pumped water into the water bag in the car and air expelled out of the car shade through the air nozzle.

FIG. 5 is a plain view of the water bag according to the present invention.

### DETAILED DESCRIPTION OF THE PREFERRED EMBODIMENT

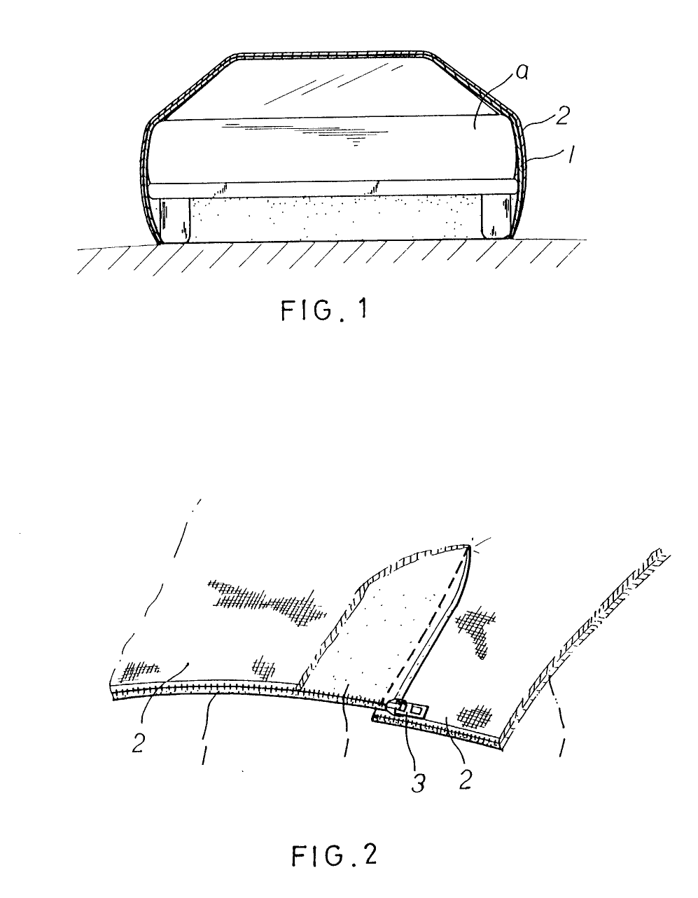

Referring to FIGS. 1, 2, 3, and 3A, a car shade is shown comprising an inner layer 1, and an outer layer 2. According to the present preferred embodiment, the outer layer 2 is detachably fastened to the inner layer by a zip fastener 3. Alternatively, the outer layer 2 can be fixedly fastened to the inner layer 1 by stitches or a bonding agent.

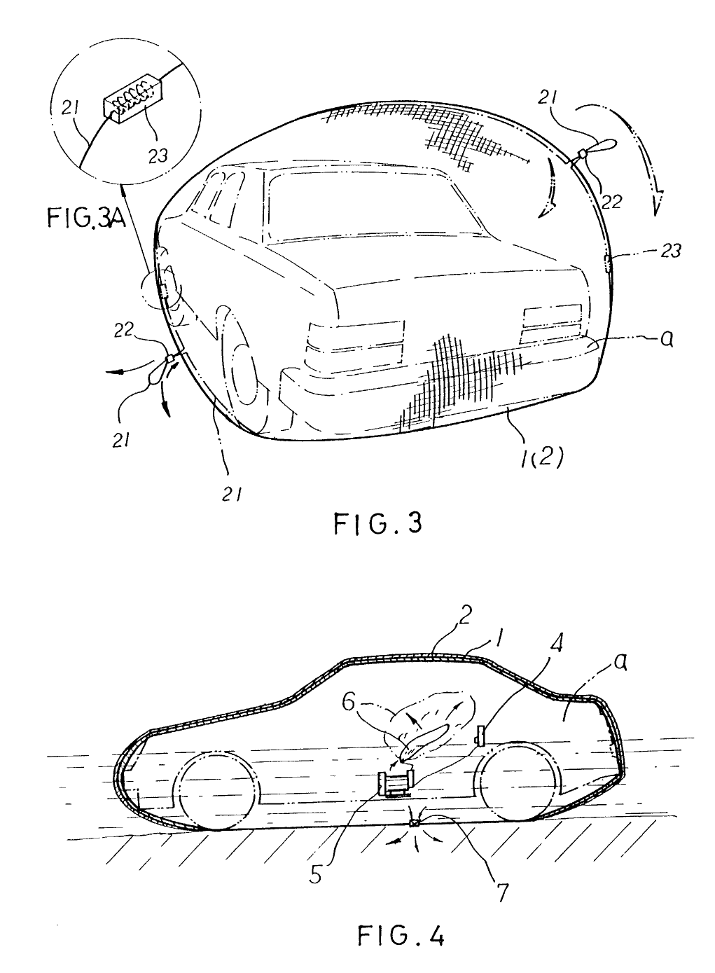

The inner layer 1 is a hollow cover shell made of waterproof material and adapted to cover the whole body of a car a on the ground. The outer layer 2 has a meshed structure made of tough material, a pull cord 21 at one side of the opening thereof, and two sliding retainers 22 at the ends of the pull cord 21. Further, the pull cord 21 has a spring member 23 connected between two cord sections thereof (see FIG. 3A). When in use, the car shade is covered on the car a around the wheels of the car a, keeping the periphery of the opening of the car shade closely attached to the ground (see FIG. 1), and then the sliding retainers 22 are respectively moved on the pull cord 21 toward the car a to firmly secure the car shade to the car a. Because the periphery of the opening of the car shade is closely attached to the ground when covered on the car a, it is maintained in a substantially closed status. Further, because the pull cord 21 has a part formed of the spring member 23, it is stretchable to set off wind force, preventing the car shade from been forced out of the car a by a strong wind.

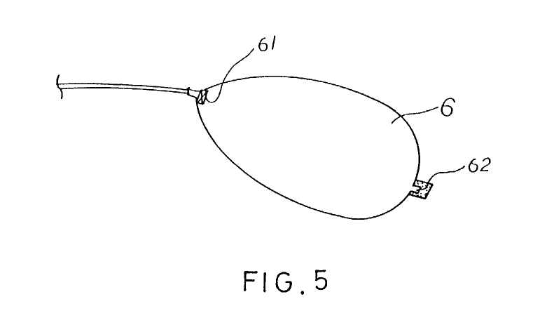

Referring to FIGS. 4 and 5, the car shade further comprises a water level sensor 4 provided inside the inner layer 1, and an air nozzle 7 disposed at a bottom side. A water bag 6 and a water pump 5 are provided inside the car a. The water bag 6 has a water inlet mounted with an one-way valve 61, which enables water to pass into the inside of the water bag 6 and prohibits water from flowing out of the water bag 6. When installed, the water pump 5 is electrically connected to the water level sensor 4. When the water level surpassed the elevation of the water level sensor 4 upon a flood, the water level sensor 4 is induced to drive the water pump 5, thereby causing the water pump 5 to pump outside water into the water bag 6 in the car a so as to increase the weight of the car a and to prevent floating of the car a in the flood. When the water bag 6 filled with water, an equal amount of air is expelled out of the car a and the car shade to the outside through the air nozzle 7. The water bag 6 further comprises a drain hole 62, which is normally sealed. After each use, the drain hole 62 is opened to drain the water bag 6. Further, the water pump 5 can be electrically connected to the car battery circuit of the car a to obtain the necessary working voltage from the car a. Alternatively a storage battery can be installed in the car a to provide power to the water pump 5.

A prototype of car shade and flood protection arrangement has been constructed with the features of FIGS. 1˜5. The car shade and flood protection arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A car shade and flood protection arrangement comprising a car shade adapted for covering the whole body of a car around the wheels of the car, said car shade comprising a hollow waterproof inner layer fitting over the body of the car to be protected, a meshed outer layer made of tough material and fastened to said waterproof inner layer, and a pull cord adapted to fasten said inner layer and said outer layer to a bottom side of the wheels of the car to be protected, said pull cord having two cord sections and a spring member connected between said cord sections.

2. The car shade and flood protection arrangement as claimed in claim 1, wherein said outer layer is fastened to said inner layer by zippers.

3. The car shade and flood protection arrangement as claimed in claim 2, wherein said outer layer is fastened to said inner layer by stitches.

4. The car shade and flood protection arrangement as claimed in claim 2, wherein said outer layer is adhered to said inner layer.

5. The car shade and flood protection arrangement as claimed in claim 1 further comprising:
a water level sensor mounted inside said inner layer and adapted to detect the level of water outside the car protected by said car shade upon a flood;
a water bag mounted inside the car protected by said car shade; and
a water pump electrically connected to said water level sensor and controlled by said water level sensor to pump water outside the car protected by said car shade into said water bag to increase the weight of the car protected by said car shade when the level of water outside the car protected by said car shade surpassed a predetermined level.

6. The car shade and flood protection arrangement as claimed in claim 5, wherein said water bag has an one-way valve provided in a water inlet thereof for letting water pass to the inside of said water bag, and a drain hole.

7. The car shade and flood protection arrangement as claimed in claim 5 further comprising an air nozzle provided at a bottom side of said car shade for letting air be expelled out of said car shade upon a flood when said water bag is filled with water.
